(19) United States
(12) Patent Application Publication
(10) Pub. No.: US 2015/0288849 A1
(43) Pub. Date: Oct. 8, 2015

(54) METHODS AND SYSTEMS FOR MERGING AND INCLUDING ADDITIONAL ELECTRONIC DOCUMENTS IN A SCAN JOB

(71) Applicant: Xerox Corporation, Norwalk, CT (US)

(72) Inventors: Gavan Tredoux, Penfield, NY (US); Roger T. Kramer, Rochester, NY (US); Premkumar Rajendran, Pondicherry (IN); Raja Dorairaj, Tamil Nadu (IN); Sainarayanan Gopalakrishnan, Chennai (IN)

(73) Assignee: Xerox Corporation, Norwalk, CT (US)

(21) Appl. No.: 14/243,289

(22) Filed: Apr. 2, 2014

(51) Int. Cl. H04N 1/387; H04N 1/00

(52) U.S. Cl. CPC H04N 1/3871; H04N 1/00307; H04N 1/00214; H04N 1/00244; H04N 2201/0094; H04N 2201/0075

(57) ABSTRACT

Methods and systems for merging and including an additional electronic document in a scan job. The scan job can be initiated and controlled by an application module running on a mobile communications device and the scan job can be stored in a buffer associated with a MFD scanner. A scan option to merge the scan job with the additional electronic document can be selected via the mobile communications device. The additional electronic document can be decomposed into pages by an interpreter and stored in the buffer. The scan job and the decomposed electronic document stored in the buffer can be delivered to a marshaling service running on a network. The additional electronic document can be added to the scan job based on an order of merging in order to generate a combined electronic document by an electronic document builder configured with the marshaling service.

### FIELD OF THE INVENTION

Embodiments are generally related to multi-function devices such as, for example, printers, scanners, photocopy machines, and the like. Embodiments are also related to mobile telecommunications devices such as, for example, smartphones, tablet computing devices, and so forth. Embodiments are additionally related to the inclusion of electronic documents in a scan job.

### BACKGROUND

A MFD (Multi-Function Device) is a rendering device or office machine which incorporates the functionality of multiple devices in a single apparatus or system so as to leave a smaller footprint in a home or a small business setting, or to provide centralized document management/distribution/production in the context of, for example, a large-office setting. A typical MFD may provide a combination of some or all of the following capabilities: printer, scanner, photocopier, fax machine, e-mail capability, and so forth. Networked MFDs generally interact with an assemblage of varying rendering devices, client computers, servers, and other components that are connected to and communicate over a network.

A document management system (DMS) is a computer system (or a set of computer programs) that can be utilized to track and store an electronic document. A DMS is also capable of tracking different versions modified by different users (i.e., history tracking). Maintaining documents in an electronic form requires less space and permits the documents to be accessed by multiple users without having to make additional rendered copies. In some circumstances, a user may wish to merge a scanned document data with an existing electronic document data.

For example, a user may scan in documents from paper, but have other relevant information in the electronic document (e.g., a PDF document, Microsoft Word document, an image file, etc.) and may want to include that information with the scan job so that the recipients, whether people or systems, can use it. Conventional techniques for adding/appending scan pages to the electronic document stored in a mass storage device or in a cloud is accomplished by scanning the electronic document to a separate PDF file and then employing certain software to merge the scanned files. Such an approach requires hardware modifications to the existing scanner or multifunction device and is time-consuming and labor intensive.

Based on the foregoing, it is believed that a need exists for improved methods and systems for including additional electronic documents or data in a scan job. A need also exists for merging the scan job with the electronic document, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved methods and systems for managing a MFD (Multi-Function Device) such as a printer, scanner, photocopy machine, fax machine, etc., or a combination thereof.

It is another aspect of the disclosed embodiments to provide for improved methods and systems for including additional electronic document in a scan job.

It is yet aspect of the disclosed embodiments to provide for improved methods and systems for merging a scan job with an electronic document.

The aforementioned aspects and other objectives and advantages can now be achieved as described herein. Methods and systems are disclosed for merging and including additional electronic documents in a scan job. In one embodiment, a scan job can be initiated and controlled via an application module running on or associated with a mobile communications device (e.g., smartphone, table computer, laptop computer, etc.) and the scan job can be stored in a buffer associated with a MFD scanner. A scan option to merge the scan job with the additional electronic document can be selected via on the mobile communications device.

The additional electronic document (e.g., a PDF document, a Microsoft Word document, an image file, etc.) can be decomposed into pages by an interpreter and stored in the buffer. The scan job and the decomposed electronic document stored in the buffer can be delivered to a marshaling service running on a network. The additional electronic document can be added to the scan job based on an order of merging in order to generate a combined electronic document by an electronic document builder configured with the marshaling service. The combined electronic document can be delivered to multiple endpoints based on user preference by the marshaling service.

A variety of connection mechanisms can be implemented in accordance with alternative embodiments. For example, NFC, QR Codes, pint numbers, or even low-power Bluetooth implementations are possible. In the case of NFC, a “tag” (e.g., NFC) on the MFD can be “touched” to launch the mobile application module that is configured to use that particular MFD and/or a user may explicitly run the mobile application module to select the intended MFD from a list. The mobile application module instructs the MFD to deliver the scanned images to the marshaling service when the user initiates the scan job. Alternatively, the mobile communications device may read the scanned images back from the MFD and deliver them to the marshaling service on the Internet (or other networked location reachable by the MFD). The marshaling service may also be configured in association with the mobile communications device. The mobile application permits the user to select one or more destinations for the scan job, e.g., a content management system on the Internet, a local network, a FTP site, email or similar endpoint. It can be appreciated that the disclosed embodiments are not limited to NFC implementations, which are discussed herein for exemplary purposes only.

The electronic document can be, for example, a PDF file, multipage TIFF files stored in USB storage (or from cloud), a picture captured by an image capturing unit on the mobile communications device or a picture from the mobile communications device gallery or storage on the mobile communications device. The user may also create the electronic document by typing a text note or annotation on the mobile communications device keyboard, recording audio or video content, drawing a picture, and so on.

The electronic document can be merged with the scanned pages in the MFD by the electronic document builder based on the order of merging. The combined electronic document can be stored back in a mass storage device or in a cloud or send by email. The electronic document builder merges all the pages into a new file or overwrites an old file. The pages in the electronic document can be reordered and the electronic document can be rendered in between multiple copy jobs. A rasterization of the existing electronic document results in all the pages being normalized and stored in the buffer, permitting existing services to act on them. If there is no additional content, the scan job as received from the MFD can be delivered.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates an example of a multi-function device coupled to a data-processing apparatus through a network, in accordance with the disclosed embodiments;

FIG. 2 illustrates a graphical representation of a device management system having an electronic document and scan job merging module associated with a network, in accordance with the disclosed embodiments;

FIG. 3 illustrates a block diagram of an electronic document and scan job merging system, in accordance with the disclosed embodiments;

FIG. 4 illustrates a high level flow chart of operations illustrating logical operational steps of a method for merging and including additional electronic document in the scan job, in accordance with the disclosed embodiments; and

FIGS. 5-7 illustrate a GUI depicting inclusion of additional electronic document in the scan job, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The disclosed embodiments are described in part below with reference to flowchart illustrations and/or block diagrams of methods, systems, computer program products and data structures according to varying embodiments, preferred and alternative. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

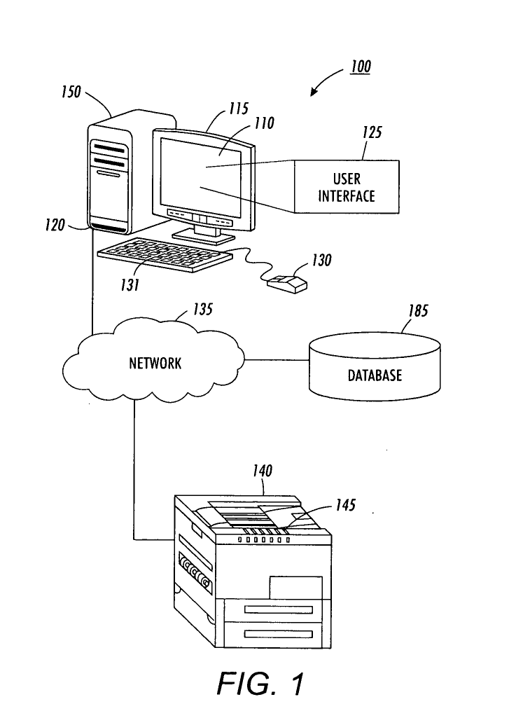

Referring to FIG. 1, system 100 can be configured to include one or more networked devices such as networked device 140 coupled to a data-processing apparatus 110 through a network 135. In some embodiments, networked device 140 may be a rendering device such as a printer, scanner, copy machine, etc. In other embodiments, networked device 140 may be a MFD, a file server, and/or a print server. The data-processing apparatus 110 may be, for example, a personal computer or other computing device, and generally includes a central processor 120, a display device 115, and a user input component (e.g., keyboard 131, mouse 130, etc.).

Note that as utilized herein, the term networked device may refer to an apparatus or system such as a printer, scanner, fax machine, copy machine, etc., and/or a combination thereof (e.g., a MFD). Preferably, networked device 140 is a MFD capable of multiple rendering functions such as printing, copying, scanning, faxing, etc. In some embodiments, the MFD 140 may be implemented with a single rendering function such as printing. In other embodiments, the MFD 140 can be configured to provide multiple rendering functions such as scanning, faxing, printing, and copying.

The data-processing apparatus 110 can be coupled to the MFD 140 (and other rendering devices) through a computer network 135. Network 135 may employ any network topology, transmission medium, or network protocol. The network 135 may include connections such as wire, wireless communication links, or fiber optic cables. In the depicted example, network 135 is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages.

The networked MFD 140 includes a user interface 145 such as a panel menu. The panel menu may be used to select features and enter other data in the device 140. Such interfaces may include, for example, touch screens having touch activated keys for navigating through an option menu or the like. A driver program, for example, can be installed on the data-processing apparatus 110 and can reside on the host device's hard drive 150. The driver program may be activated through an application interface so that a user may generate a rendering job with the driver for processing by the MFD 140.

The data-processing apparatus 110 also includes a GUI 125 for communicating rendering features for processing, for example, the rendering job to a user and accepting the user's selection of available rendering features. The user interface 125 displays information and receives data through device display and/or the keyboard/mouse combination. The interface 125 also serves to display results, whereupon the user may supply additional inputs or terminate a given session. The data-processing apparatus 110 can be, for example, any computing device capable of being integrated within a network such as a PDA, personal computer, cellular telephone, point-of-sale terminal, server, etc.

The input device of the networked device 140, for example, may be a local user interface 145 such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the disclosed embodiments, which can be embodied in the context of the data-processing apparatus 110 and the networked device 140 depicted in FIG. 1. The disclosed embodiments, however, is not limited to any particular application or any particular environment. Instead, those skilled in the art will find that the system and methods of the disclosed embodiments may be advantageously applied to a variety of system and application software including database management systems, word processors, and the like. Moreover, the embodiments can be implemented on a variety of different platforms including Microsoft Windows, Macintosh, UNIX, LINUX, and so on. With respect to mobile applications, mobile operating systems such as Android, Apple, Blackberry, and so forth may be employed for specific mobile applications. Therefore, the description of the exemplary embodiments, which follows, is for purposes of illustration and not considered a limitation.

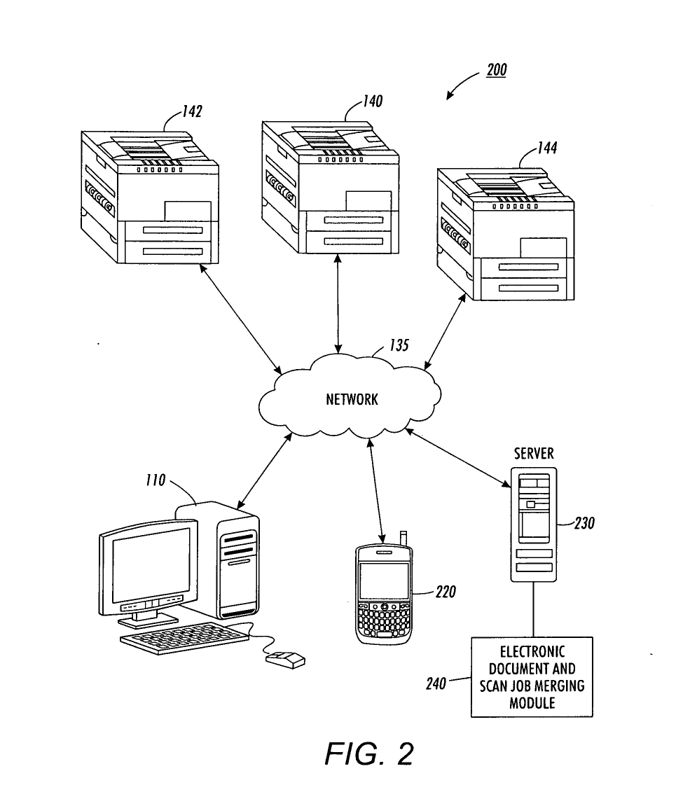

FIG. 2 illustrates a graphical representation of a device management system 200 having an additional electronic document and scan job merging module 240 associated with a network 135, in accordance with the disclosed embodiments. The device management system 200 generally includes the network infrastructure associated with one or more networked MFDs 140, 142, and 144, data-processing system 110, a mobile communications device 220, and an EIP server 230. Note that the mobile communications device can be, for example, a smartphone, a tablet computing device or other appropriate mobile device. Data-processing apparatus 110 depicted in FIG. 1 can be, for example, a server. Other devices such as, for example, desktops, network devices, smartphones, tablet computing devices, etc., may also be included in the network 135 as service providers. The MFDs 140, 142, and 144 can be located remotely with respect to each other, or alternatively, they may be located locally with respect to each other.

The typical MFD may act as a combination of a printer, scanner, photocopier, fax, and e-mail. While three MFDs 140, 142, and 144 are shown by way of example, it is to be appreciated that any number of MFDs may be linked to the network such as four, six or more rendering devices. In general, the MFDs 140, 142, and 144 can be employed to perform a rendering output function (e.g., printing, scanning, copying, faxing, etc.) within a networked environment. Note that MFDs 140, 142, and 144 are generally analogous to one another.

The electronic document and scan job merging module 240 associated with the server 230 can be adapted for merging and including additional electronic document in a scan job. Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media including transmission media and recordable media. Various embodiments are capable of being distributed as a program product in a variety of forms, which apply equally regardless of the particular type of signal-bearing media utilized to carry out the distribution.

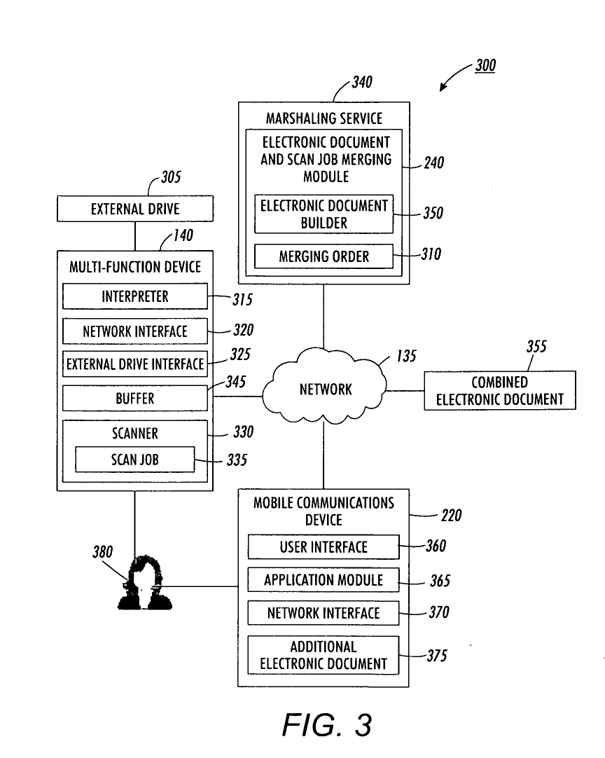

FIG. 3 illustrates a block diagram of an electronic document and scan job merging system 300, in accordance with the disclosed embodiments. The electronic document and scan job merging system 300 generally includes the MFD 140 having a scanner 330 connected to the mobile communications device 220 having a mobile application module 365. The electronic document and scan job merging system 300 further includes a marshaling service 340 running on the network 135 for marshaling a scan job 335. The MFD 140 can be connected to the network 135 via a network interface 320.

The software application module 365 with respect to the mobile communications device 220 can initiate and control the scan job 335 with respect to the MFD 140. As indicated earlier, a variety of connection mechanisms are possible. For example, QR Codes, pin numbers, and even low-power Bluetooth embodiments can be implemented. In the case of NFC, a “tag” (e.g., NFC) on the MFD can be touched or tapped to launch the mobile application 365, which can be configured to employ the particular MFD 140 and/or the user 380 may explicitly run the mobile application module 365 to select the intended MFD 140 from a list. The user 380 can load the paper documents or objects to be scanned onto the ADF or platen of the MFD 140, or similar receptacle. Again, as indicated previously, reference herein to NFC is for illustrative purposes only and alternative embodiments can be implemented with other connection mechanisms such as QR Codes, pin numbers, Bluetooth, etc.

The mobile application module 365 instructs the MFD 140 to deliver the scan job 335 to the marshaling service 340 when the user 380 initiates the scan job 335. Alternatively, the mobile communications device 220 may read the scanned images back from the MFD 140 and deliver them to the marshaling service 340 on the Internet (or other networked location reachable by the MFD 140). The marshaling service 340 may also be configured in association with the mobile communications device 220. The mobile application module 365 permits the user 380 to select one or more destinations for the scan job 335, e.g., a content management system on the Internet, a local network, a FTP site, email or similar endpoint. The MFD 140 also stores the scan job 335 in a buffer 345 associated with the MFD 140.

In some embodiments, the mobile communications device 220 can display a scan option to merge the scan job 335 with the additional electronic document 375 that can be selected by the user 380. Note that the electronic document 375 can be, for example, a PDF document, a Microsoft Word or multipage TIFF files stored in an external drive 305 (e.g., USB drive) or cloud storage, a picture captured by an image capturing unit on the mobile communications device 220 or a picture from the mobile communications device 220 gallery or storage on the mobile communications device 220. The user 380 may also create the electronic document 375 by typing a text note or annotation on the mobile communications device 220 keyboard, recording audio or video content, drawing a picture, and so on. The external drive 305 can be connected to the MFD via an external drive interface 325 configured with the MFD 140.

Note that in some embodiments, a file can be generated either by the mobile application or the marshalling service (e.g., map indicating where the scan was created using GPS coordinates supplied by a sensor association with the mobile communications device 220). In other words, embodiments are not limited to files already on the mobile communications device 220, with the exception of, for example, voice annotation.

An interpreter 315 associated with the MFD 140 decomposes the additional electronic document 375 into pages and stores it in the buffer 345. The marshaling service 340 running on the network 135 receives the scan job 335 and the decomposed electronic document stored in the buffer 345. An electronic document builder 350 configured with the electronic document and scan job merging module 240 generates a combined electronic document 355 by adding the additional electronic document 375 to the scan job 335 based on an order of merging 310. The marshaling service 340 delivers the combined electronic document 355 to multiple endpoints based on user preference.

The combined electronic document 355 can be stored back in a mass storage device or in a cloud or sent by email. The electronic document builder 350 merges all the pages into a new file or overwrites the old file. The pages in the electronic document 375 can be reordered and the electronic document 375 can be rendered in between multiple copy jobs. A rasterization of the existing electronic document 375 results in all the pages being normalized and stored in the buffer 345 permitting existing services to act on them. If there is no additional content, the scan job 335 as received from the MFD 140 can be delivered.

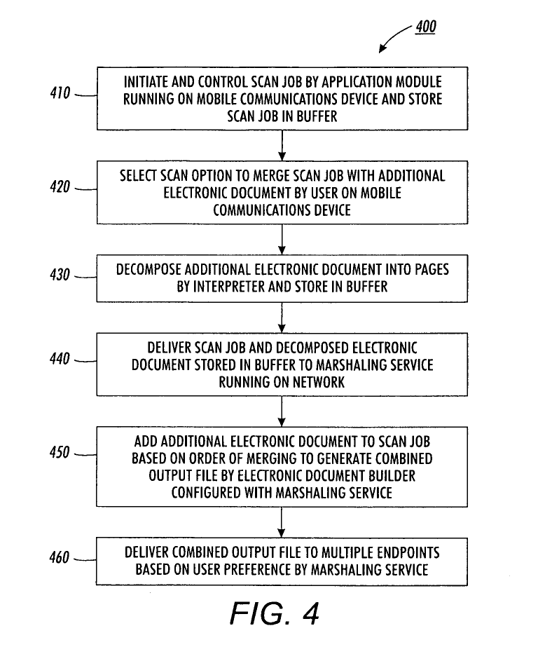

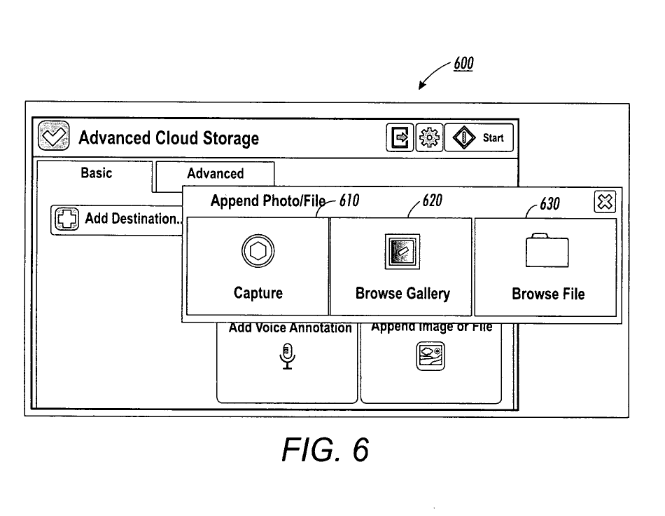

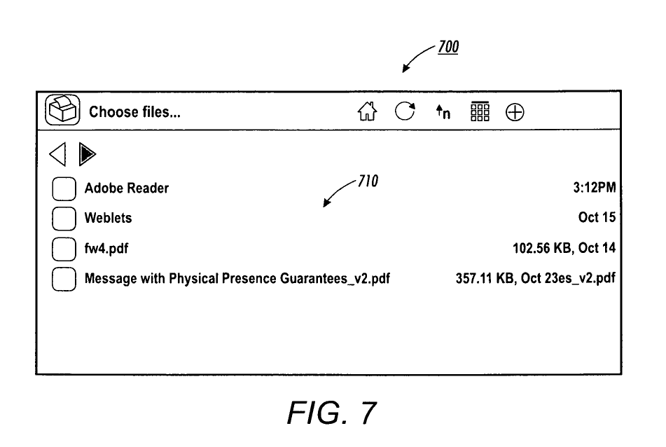

FIG. 4 illustrates a high level flow chart of operations illustrating logical operational steps of a method 400 for merging and including additional electronic document 375 in the scan job 335, in accordance with the disclosed embodiments. Note that in FIGS. 1-7, identical or similar blocks are generally indicated by identical reference numerals. The scan job 335 can be initiated and controlled by the application module 365 running on the mobile communications device 220 and the scan job 335 can be stored in the buffer 345 associated with the MFD 140, as indicated at block 410. The scan option to merge the scan job 335 with the additional electronic document 375 can be selected by the user 380 on the mobile communications device 220, as shown at block 420.

The additional electronic document 375 can be decomposed into pages by the interpreter 315 and stored in the buffer 345, as illustrated at block 430. The scan job 335 and the decomposed electronic document stored in the buffer 345 can be delivered to the marshaling service 340 running on the network 135, as mentioned at block 440. The additional electronic document 375 can be added to the scan job 335 based on an order of merging in order to generate the combined electronic document 355 by the electronic document builder 350 configured with the marshaling service 340, as indicated at block 450. The combined electronic document 355 can be delivered to multiple endpoints based on user preference by the marshaling service 340, as shown at block 460.

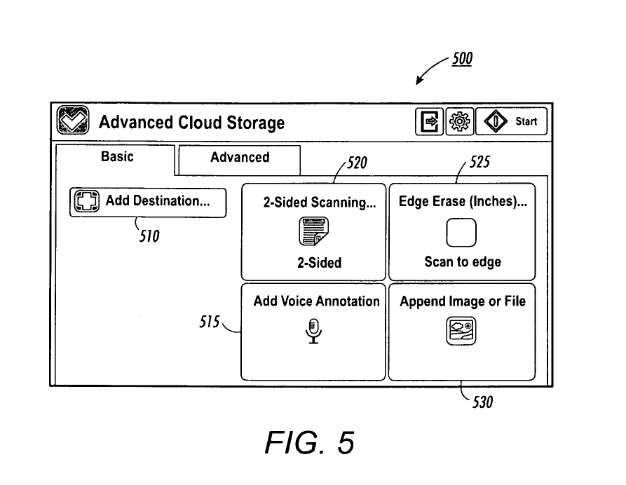

FIGS. 5-7 illustrate a GUI depicting inclusion of additional electronic document 375 in the scan job 335, in accordance with the disclosed embodiments. The GUI 500 includes an add destination button 510 to permit the user 380 to select one or more destinations for the scan job 335, e.g., content management system on the Internet, local network, FTP site, email or similar endpoint. A 2-sided scanning button 520, a voice annotation button 515, and an edge erase button 525 can be selected to enhance the scanning process. An append image or file button 530 can be pressed to add a picture with respect to the scan job 335.

Note that the user interface as utilized herein generally refers to a type of environment that represents programs, files, options, and so forth by means of graphically displayed icons, menus, and dialog boxes on a screen. A user can interact with the user interface to select and activate such options by pointing and clicking with a user input device such as, for example, a touch screen, a keyboard or the like. A particular item can function in the same manner to the user in all applications because the user interface provides standard software routines to handle these elements and reports the user's actions. Note that GUI 500, 600, and 700 can be implemented utilizing a GUI such as the GUI 125 depicted in FIG. 1 and can be provided by a module such as, for example, module 240.

The GUI 600 illustrates buttons 610, 620, and 630 to capture a picture by the image capturing unit on the mobile communications device 220 or a picture from the mobile communications device 220 gallery or file stored on the mobile communications device 220, respectively. The GUI 700 illustrates electronic files 710 that can be added with respect to the scan job 335. For example, when the user 380 wants to submit a filled form with annexure (e.g., address proof, identification proof, etc.) instead of having multiple files, the system 300 is enabled to have one single file created in MFD. The system 300 combines scanned pages with existing PDF (and/or TIF) files directly from the MFD 140 for end users.

Based on the foregoing, it can be appreciated that a number of embodiments, preferred and alternative, are disclosed herein. For example, in one embodiment, a method can be implemented for merging and including additional electronic documents in a scan job. Such a method can include the steps or logical operations of initiating and controlling a scan job with respect to a multi-function device by an application module running on or with respect to a device and storing the scan job in a buffer associated with the multi-function device; decomposing an additional electronic document into a plurality of pages by an interpreter associated with the multi-function device to thereafter store the decomposed electronic document in the buffer; delivering the scan job and the decomposed electronic document stored in the buffer to a marshaling service running on a network; and adding the additional electronic document to the scan job based on an order of merging in order to generate a combined electronic document by an electronic document builder configured with the marshaling service.

In another embodiment, the aforementioned device can be a mobile communications device such as a smartphone, tablet computing device, laptop computer, etc. In yet another embodiment, a step or logical operation can be provided for selecting a scan option to merge the scan job with the additional electronic document by the user via the mobile communications device. In another embodiment, a step or logical operation can be provided for instructing the multi-function device to deliver the scan job to the marshaling service by the mobile application module when the user initiates the scan job. In still another embodiment, a step or logical operation can be implemented for reading the scan job back from the multi-function device and delivering the scan job to the marshaling service by the mobile communications device. In yet another embodiment, a step of logical operation can be provided for associating the marshaling service with the mobile communications device.

In other embodiments, the electronic document can be at least one of the following types of documents: a page description file and/or a word file stored in an external storage device; a multipage TIFF file stored in the external storage device; a picture captured by an image-capturing unit associated with the mobile communications device; a picture from the mobile communications device gallery; a text note and annotation created by typing on the mobile communications device keyboard; a recording audio and video content; or a picture drawn by the user.

In another embodiment, a step or logical operation can be provided for merging the plurality of pages with respect to the electronic document into a new file. In still another embodiment, a step or logical operation can be implemented for merging the plurality of pages with respect to the electronic document by overwriting an “old” file. In yet another embodiment, steps or logical operations can be provided for reordering the plurality of pages in the electronic document; and rendering the electronic document between multiple copy jobs. In yet another embodiment, a step or logical operation can be provided for delivering the scan job as received from the multi-function device if there is no additional content.

In another embodiment, a system for merging and including additional electronic documents in a scan job can be implemented. Such a system can include, for example, a processor; and a computer-usable medium embodying computer program code, the computer-usable medium capable of communicating with the processor. The computer program code can include instructions executable by the processor and configured for example, for: initiating and controlling a scan job with respect to a multi-function device by an application module running on or with respect to a device and storing the scan job in a buffer associated with the multi-function device; decomposing an additional electronic document into a plurality of pages by an interpreter associated with the multi-function device to thereafter store the decomposed electronic document in the buffer; delivering the scan job and the decomposed electronic document stored in the buffer to a marshaling service running on a network; and adding the additional electronic document to the scan job based on an order of merging in order to generate a combined electronic document by an electronic document builder configured with the marshaling service.

In yet another embodiment, a processor-readable medium storing code representing instructions to cause a process for merging and including additional electronic documents in a scan job can be implemented. Such code can include code to, for example: initiate and controlling a scan job with respect to a multi-function device by an application module running on or with respect to a device and storing the scan job in a buffer associated with the multi-function device; decompose an additional electronic document into a plurality of pages by an interpreter associated with the multi-function device to thereafter store the decomposed electronic document in the buffer; deliver the scan job and the decomposed electronic document stored in the buffer to a marshaling service running on a network; and add the additional electronic document to the scan job based on an order of merging in order to generate a combined electronic document by an electronic document builder configured with the marshaling service.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for merging and including additional electronic documents in a scan job, said method comprising:
initiating and controlling a scan job with respect to a multi-function device by an application module running on or with respect to a mobile communications device and storing said scan job in a buffer associated with said multi-function device;
decomposing an additional electronic document into a plurality of pages, wherein the additional electronic document comprises more than one page;
storing the plurality of pages in said buffer; and
delivering said scan job and said plurality of pages to a marshaling service running on a server connected to a network wherein said marshaling service merges
said plurality of pages to said scan job based on an order of merging to thereby generate a combined electronic document.

2. The method of claim 1 wherein said mobile communications device comprises an application, wherein said multi-function device comprises an NFC tag, wherein touching or tapping the mobile communications device to the NFC tag causes the mobile communications device launch the application, and wherein the application interacts with the multi-function device.

3. The method of claim 1 further comprising rasterizing the plurality of pages such that the plurality of pages are normalized and stored in the buffer.

4. The method of claim 1 further comprising said mobile communications device instructing said multi-function device to deliver said scan job to said marshaling service when said scan job is initiated.

5. The method of claim 1 further comprising reading said scan job back from said multifunction device and delivering said scan job to said marshaling service by said mobile communications device.

6. The method of claim 1 wherein the additional electronic document comprises audio content (note—turn this into a linking claim).

7. The method of claim 1 wherein said additional electronic document comprises at least one of the following types of documents:
a page description file and/or a word file stored in an external storage device;
a multipage TIFF file stored in said external storage device;
a picture captured by an image-capturing unit associated with said mobile communications device;
a picture from said mobile communications device gallery;
a text note and annotation created by typing on said mobile communications device keyboard;
a recording audio and video content; or
a picture drawn by said user.

8. The method of claim 1 further comprising merging said plurality of pages with respect to said electronic document into a new file.

9. The method of claim 1 further comprising merging said plurality of pages with respect to said electronic document by overwriting an old file.

10. The method of claim 1 further comprising:
reordering said plurality of pages in said electronic document; and
rendering said electronic document between multiple copy jobs.

11. The method of claim 1 further comprising delivering said scan job as received from said multi-function device if there is no additional content.

12. A system for merging and including additional electronic documents in a scan job, said system comprising:
a processor; and
a computer-usable medium embodying computer program code, said computer usable medium capable of communicating with the processor, said computer program code comprising instructions executable by said processor and configured for:
initiating and controlling a scan job with respect to a multi-function device by an application module running on or with respect to a device and storing said scan job in a buffer associated with said multi-function device;
decomposing an additional electronic document into a plurality of pages, wherein the additional electronic document is a multi-page PDF document;
storing the plurality of pages in said buffer; and
delivering said scan job and said plurality of pages to a marshaling service running on a network,
wherein the marshalling service merges said plurality of to said scan job based on an order of merging in order to generate a combined electronic document.

13. The system of claim 12 wherein said instructions are further configured for selecting a scan option to merge said scan job with said additional electronic document by a user of said mobile communications device.

14. The system of claim 12 wherein said instructions are further configured for instructing said multi-function device to deliver said scan job to said marshaling service by said mobile communication device.

15. The system of claim 12 wherein said instructions are further configured for reading said scan job back from said multi-function device and delivering said scan job to said marshaling service by said mobile communications device.

16. The system of claim 12 wherein said instructions are further configured for associating said marshaling service with said mobile communications device.

17. The system of claim 12 wherein said instructions are further configured for merging said plurality of pages with respect to said electronic document into a new file.

18. The system of claim 12 wherein said instructions are further configured for merging said plurality of pages with respect to said electronic document by overwriting an old file.

19. A non-transitory processor-readable medium storing code representing instructions to cause a process for merging and including additional electronic documents in a scan job, said code comprising to:
initiate and controlling a scan job with respect to a multi-function device by an application module running on or with respect to a mobile communications device and storing said scan job in a buffer associated with said multi-function device;
decompose an additional electronic document into a plurality of pages by an;
obtaining audio content from the mobile communications device; and
deliver said scan job and said audio content to a marshaling service running on a network
wherein the marshaling service merges the audio content and said scan job based on an order of merging in order to generate a combined electronic document.

20. The processor-readable medium of claim 19 wherein said code further includes code to:
select a scan option to merge said scan job with said additional electronic document by said user on said mobile communications device; and
instruct said multi-function device to deliver said scan job to said marshaling service by said mobile application module when said user initiates said scan job.
